(19) United States
(12) Patent Application Publication
(10) Pub. No.: US 2004/0066976 A1
(43) Pub. Date: Apr. 8, 2004

(54) Picture coding method and picture coding apparatus

(75) Inventor: Kazuyuki Inokuma, Kyoto (JP)

Correspondence Address: Jack Q. Lever, Jr., McDERMOTT, WILL & EMERY, 600 Thirteenth Street, N.W., Washington, DC, 20005-3096, US

(73) Assignee: MATSUSHITA ELECTRIC INDUSTRIAL CO., LTD.

(21) Appl. No.: 10/642,223

(22) Filed: Aug. 18, 2003

(30) Foreign Application Priority Data
Oct. 3, 2002 (JP) 2002-290947

(51) Int. Cl. G06K 9/36; G06K 9/46

(52) U.S. Cl. 382/239; 382/234; 382/236

(57) ABSTRACT

With respect to an input image, a plurality of coded data respectively having different coding quantities are generated, and n reference images are created from these coded data. The reference images are subjected to image quality evaluation, and coded data is selected on the basis of the result of the image quality evaluation. In other words, coded data is selected on the basis of the result of the image quality evaluation of the reference images identical to images obtained in reproducing. Accordingly, the coding quantity can be controlled in consideration of the image quality, so as to definitely obtain coded data having an appropriate coding quantity and high image quality.

### BACKGROUND OF THE INVENTION

The present invention relates to picture coding for compaction of a moving picture image, and more particularly, it relates to technique to improve the accuracy in coding quantity control employed in real-time coding necessary for consumer video recorders and video cameras.

FIG. 17 is a flowchart of a picture coding method including conventional coding quantity control. In the conventional coding quantity control, coding quantity is made to fall in a predetermined range by determining a parameter to be used in subsequent coding on the basis of the coding quantity of previously coded data (See, for example, Japanese Laid-Open Patent Publication No. 7-107473). First, a first frame of a picture image is input (SZ1), and a first macroblock is coded by using a previously determined initial parameter (SZ2). It is noted that the coding is performed in each rectangular area designated as a macroblock. With respect to each of the following macroblocks, the coding quantity of a previously coded macroblock is calculated (SZ3), and it is determined whether the calculated coding quantity is larger or smaller than a predetermined target value. Thus, the coding parameter is controlled so that the coding quantity of the currently processed macroblock can be smaller when the calculated coding quantity is larger or so that the coding quantity of the currently processed macroblock can be larger when the calculated coding quantity is smaller (SZ4). When a next frame image is input (SZ5), the coding quantity of the previously processed frame is also used for calculating a difference in the coding quantity from the target value (SZ6), so as to control the coding parameter to be subsequently used (SZ7). These steps SZ5 through SZ7 are repeatedly executed until the last frame is processed (SZ8).

However, since this conventional method employs the feedback method in which a subsequently used coding parameter is controlled on the basis of previously coded data, there is no guarantee that the optimum coding quantity can be always selected. For example, if a too large coding quantity is initially provided, a subsequent image that should be provided with a large coding quantity cannot be provided with a sufficient coding quantity, and therefore, the image quality may be disadvantageously largely degraded.

Also, since the coding parameter is controlled through evaluation of the coding quantity alone, it is difficult to control the coding quantity to be provided appropriately in accordance with the property of an image.

### SUMMARY OF THE INVENTION

An object of the invention is realizing, in picture coding, coding quantity control in consideration of image quality.

Specifically, the picture coding method for coding a moving picture image of this invention includes a first step of generating, with respect to a first image, a plurality of coded data respectively having different coding quantities; a second step of creating a plurality of reference images to be used for predicting coding by decoding the plurality of coded data; a third step of performing image quality evaluation on the plurality of reference images; and a fourth step of selecting at least one coded data from the plurality of coded data on the basis of a result of the image quality evaluation.

According to the present invention, a plurality of coded data respectively having different coding quantities are generated with respect to the first image, and a plurality of reference images are created from these coded data. Then, the reference images are subjected to the image quality evaluation, and coded data is selected on the basis of the result of the image quality evaluation. In other words, coded data is selected on the basis of the result of image quality evaluation of the reference images identical to images obtained in reproducing, and therefore, the coding quantity can be controlled in consideration of the image quality. Accordingly, coded data with an appropriate coding quantity and high image quality can be definitely obtained.

In the first step of the picture coding method of this invention, preferably, a plurality of target coding quantities are set, and the plurality of coded data are generated with respect to the first image, through coding performed under coding quantity control for converging coding quantities of the plurality of coded data respectively on the plurality of target coding quantities. Furthermore, preferably, the plurality of target coding quantities are set with respect to each frame, and in the coding quantity control, a coding parameter is controlled in each macroblock.

In the first step of the picture coding method of this invention, preferably, the plurality of coded data are generated with respect to the first image, through coding performed by using a plurality of different coding parameters.

In the picture coding method of this invention, preferably, the first image is provided frame by frame, and the at least one coded data is selected in each frame in the fourth step.

In the picture coding method of this invention, preferably, the first image is provided frame by frame; in the first step, n (wherein n is an integer of 2 or more) predicting coded images are created, with respect to the first image, by referring to n reference images of another frame; and with respect to each of the n predicting coded images, m (wherein m is an integer of 2 or more) coded data respectively having different coding quantities are generated, whereby generating n×m coded data as the plurality of coded data. Furthermore, preferably, in the fourth step, n coded data are selected from the n×m coded data, and n reference images respectively corresponding to the n coded data are used for the predicting coding of an image of another frame.

In the third step of the picture coding method of this invention, preferably, a reference image obtained from coded data having the largest coding quantity among the plurality of reference images is set as a referred image, and a difference of each of the reference images from the referred image is obtained and used for obtaining an evaluation value for the image quality evaluation.

Thus, a reference image obtained from coded data having the largest coding quantity, which is presumed to have the highest image quality, is set as a refereed image, and the difference of each reference image from this referred image is obtained so as to obtain an evaluation value for the image quality evaluation on the basis of the difference. Accordingly, the image quality evaluation with high accuracy can be carried out by a simple method.

In the fourth step, preferably, the at least one code data is selected from coded data corresponding to reference images having evaluation values falling in an allowable range. Alternatively, in the third step, preferably, a high frequency component is extracted from the referred image, and in obtaining the evaluation value, the difference is modulated in accordance with the high frequency component of a corresponding pixel. Thus, the difference between the images is modulated in accordance with the high frequency component of the corresponding pixel, and hence, the complexity of the image can be involved in the evaluation value for the image quality evaluation. Accordingly, the image quality evaluation can be accurately carried out by using a scale in accordance with the characteristic of eyes of humans. Alternatively, preferably, a pattern of a difference image consisting of the difference is evaluated and noise information is extracted from the pattern, and the noise information is additionally included in coded data corresponding to a corresponding one of the reference images. Thus, the extracted noise information is included in the coded data, and therefore, noise reduction processing can effectively function in reproducing the coded data. As a result, the image quality can be further improved in reproducing.

Furthermore, in the third step of the picture coding method of this invention, preferably, the image quality evaluation of the reference images is performed in each macroblock; and in the fourth step, the at least one coded data is selected in each macroblock; and the coded data selected in respective macroblocks are combined to reconstruct new coded data.

Thus, the image quality evaluation is carried out in each macroblock so as to select coded data in each macroblock. Therefore, since the coding quantity can be controlled on the basis of the image quality evaluation also within one frame, the image quality can be further improved.

Furthermore, preferably, in reconstructing the new coded data in the fourth step, some of the selected coded data that have been coded through the predicting coding are once decoded to obtain coded data having been coded without the predicting coding before reconstruction, and are subjected to the predicting coding again after the reconstruction.

In the picture coding method of this invention, preferably, the first image is provided frame by frame; in the first step, inter-coding and intra-coding are performed with respect to the first image; and in the fourth step, either of the inter-coding or the intra-coding is selected. Thus, what is called intra/inter determination is also performed on the basis of the image quality evaluation, and therefore, the image quality can be further improved.

In the fourth step of the picture coding method of this invention, preferably, the at least one coded data is selected on the basis of not only the result of the image quality evaluation but also coding quantities of the plurality of coded data. Thus, the coded data is selected on the basis of the coding quantities of the coded data in addition to the result of the image quality evaluation. Therefore, it is possible to realize coding quantity control in which variation of the coding quantity is suppressed also in serious consideration of the image quality. As a result, the size of a decoding apparatus to be used in reproducing can be suppressed.

Preferably, in the fourth step, an image quality allowable range is set as an allowable range of the evaluation value resulting from the image quality evaluation and a coding quantity allowable range is set as an allowable range of the coding quantities, and the at least one coded data is selected in accordance with a given rule from coded data having evaluation values falling in the image quality allowable range and having coding quantities falling in the coding quantity allowable range.

Preferably, in the fourth step, a coding quantity allowable range is set in each frame as an allowable range of the coding quantities, the at least one coded data is selected through the image quality evaluation in each macroblock, and when a coding quantity of a whole frame is above the coding quantity allowable range, the selection of the at least one coded data is changed, for making the coding quantity of the frame fall in the coding quantity allowable range, preferentially in a macroblock that is less degraded in the image quality and more largely reduced in the coding quantity through change of the selection. Thus, when the coding quantity of the whole frame is above the coding quantity allowable range, the selection of coded data is changed preferentially in a macroblock that is less degraded in the image quality and more largely reduced in the coding quantity. Therefore, while minimizing degradation of the image quality, the variation of the coding quantity can be suppressed.

Alternatively, the picture coding apparatus of this invention includes a picture coding unit for generating, with respect to a first image, a plurality of coded data respectively having different coding quantities; a local decoding unit for generating a plurality of reference images to be used for predicting coding by locally decoding the plurality of coded data generated by the picture coding unit; an image quality evaluation section for evaluating image qualities of the plurality of reference images generated by the local decoding unit; and a coded data selection section for selecting at least one coded data from the plurality of coded data on the basis of a result of processing executed by the image quality evaluation section.

According to the present invention, the image coding unit generates, with respect to one image, a plurality of coded data respectively having different coding quantities, and the local decoding unit creates a plurality of reference images from these coded data. Then, the image quality evaluation section performs the image quality evaluation of the respective reference images, and the coded data selection section selects coded data on the basis of the result of the image quality evaluation. In other words, coded data is selected on the basis of the image quality evaluation of the reference images identical to images obtained in reproducing, and therefore, the coding quantity can be controlled in consideration of the image quality. As a result, coded data having an appropriate coding quantity and high image quality can be definitely obtained.

Preferably, the picture coding apparatus of this invention further includes a first storage section for storing the plurality of coded data; and a second storage section for storing the plurality of reference images, and the first storage section and the second storage section are constructed by a common memory device. Thus, in an apparatus that originally includes a memory with large capacity, such as a digital camera, the existing memory can be used so as to reduce the cost.

Preferably, in the picture coding apparatus of this invention, the picture coding unit and the local decoding unit are operated in a time-sharing manner for generating combinations of the plurality of coded data and the plurality of reference images serially in time series. Thus, there is no need to provide additional hardware to generate the plural coded data and reference images. In other words, in an apparatus originally having high processing performance, such as a DVD recorder, the performance can be effectively used for generating, for example, coded data having high image quality in spite of its high compressibility, and therefore, such an apparatus can be more widely used by switching coded data to be generated in accordance with the purpose.

### BRIEF DESCRIPTION OF THE DRAWINGS

FIG. 1 is a flowchart of a picture coding method according to Embodiment 1 of the invention;

FIG. 2 is a block diagram for showing an exemplified architecture of a picture coding apparatus according to Embodiment 1 of the invention;

FIG. 3 is a flowchart of exemplified processing for evaluating image quality;

FIG. 4 is a flowchart of a picture coding method according to Embodiment 2 of the invention;

FIG. 5 is a flowchart of a picture coding method according to Embodiment 3 of the invention in which intra/inter determination is additionally performed in the picture coding method of Embodiment 1;

FIG. 6 is a flowchart of a picture coding method according to Embodiment 3 of the invention in which the intra/inter determination is additionally performed in the picture coding method of Embodiment 2;

FIG. 7 is a flowchart of a picture coding method according to Embodiment 4 of the invention;

FIG. 8 is a block diagram for showing an exemplified architecture of a picture coding apparatus according to Embodiment 4;

FIG. 9 is a flowchart of exemplified processing for reconstructing coded data;

FIG. 10 is a schematic diagram for showing the processing for reconstructing coded data;

FIGS. 11A and 11B are schematic diagrams for showing coded data selection in consideration of coding quantity;

FIGS. 12A and 12B are schematic diagrams for showing another coded data selection in consideration of coding quantity;

FIG. 13 is a diagram for showing the architecture of a general digital camera;

FIG. 14 is a diagram for showing the architecture of a picture coding unit of a digital camera to which this invention is applied;

FIG. 15 is a diagram for showing an exemplified architecture of a DVD recorder;

FIG. 16 is a diagram for showing the architecture of a picture coding unit of a DVD recorder to which this invention is applied; and

FIG. 17 is a flowchart of conventional picture coding processing.

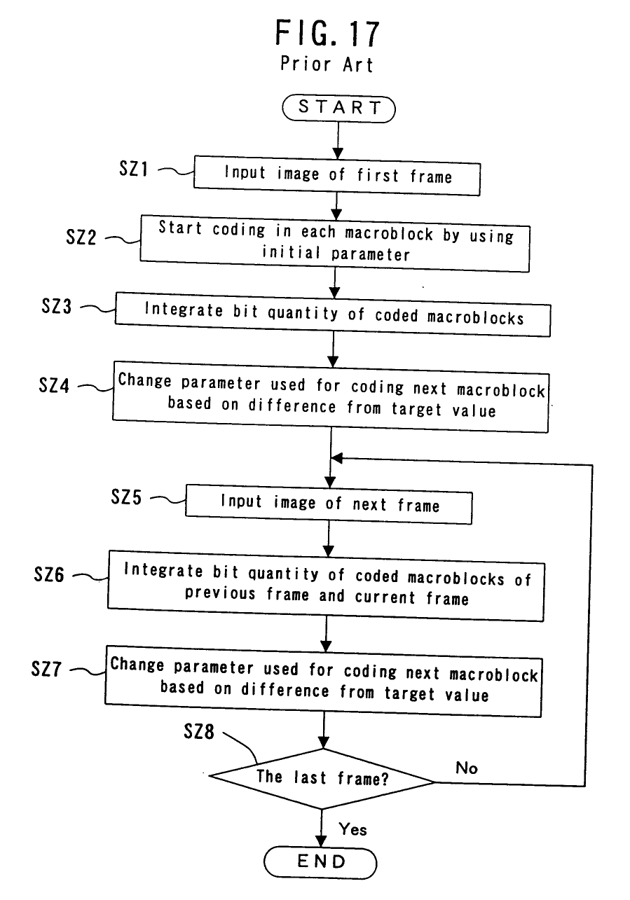

### DETAILED DESCRIPTION OF THE INVENTION

Preferred embodiments of the invention will now be described with reference to the accompanying drawings:

### EMBODIMENT 1

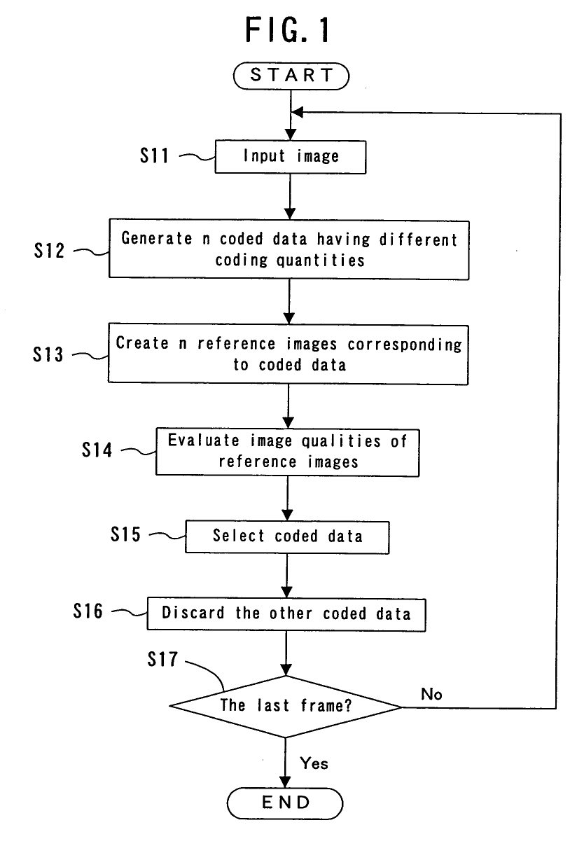

FIG. 1 is a flowchart for showing basic procedures in a picture coding method according to Embodiment 1 of the invention. As shown in FIG. 1, a first frame of a moving picture image is input (S11), and n (wherein n is an integer of 2 or more) coded data respectively having different coding quantities are generated (S12; a first step). The n coded data are respectively decoded, so as to create n reference images to be used for predicting coding (S13; a second step). Next, the n reference images are evaluated in the image quality (S14; a third step), and on the basis of the results of the image quality evaluation, optimum coded data to be recorded is selected in each frame (S15; a fourth step). The other coded data are discarded without recording (S16). These steps S11 through S16 are repeatedly executed until the last frame is processed (S17).

In this method, determination whether a difference between a reference image and an input image, namely, a predicting coded image, is coded or an input image itself is coded in the coding of a subsequent frame (which determination is hereinafter referred to as “intra/inter determination”) is carried out in each macroblock within one frame. Specifically, with respect to every image that has been subjected to the intra/inter determination in each macroblock, n coded data are generated.

In step S12, n target coding quantities are set and the coding is carried out under coding quantity control for converging the coding quantity of the frame image on each target coding quantity. In this coding quantity control, the conventional feed-back method is employed. Specifically, a coding parameter for a first macroblock is determined in accordance with the n target coding quantities set with respect to each frame, so as to perform the coding on the basis of this coding parameter, and a coding parameter for each of the following macroblocks is determined through evaluation of a difference between the coding quantity of the previously coded data and the target coding quantity. Thus, the coding quantity is controlled so that the coding quantity of the frame can be ultimately converged on the target coding quantity.

In step S12, a plurality of coded data respectively having different coding quantities may be generated through the coding using a plurality of different coding parameters. A coding parameter used herein is typically a quantization coefficient or a quantization step, and alternatively, a define Haffman table or a define quantization table may be used as the parameter.

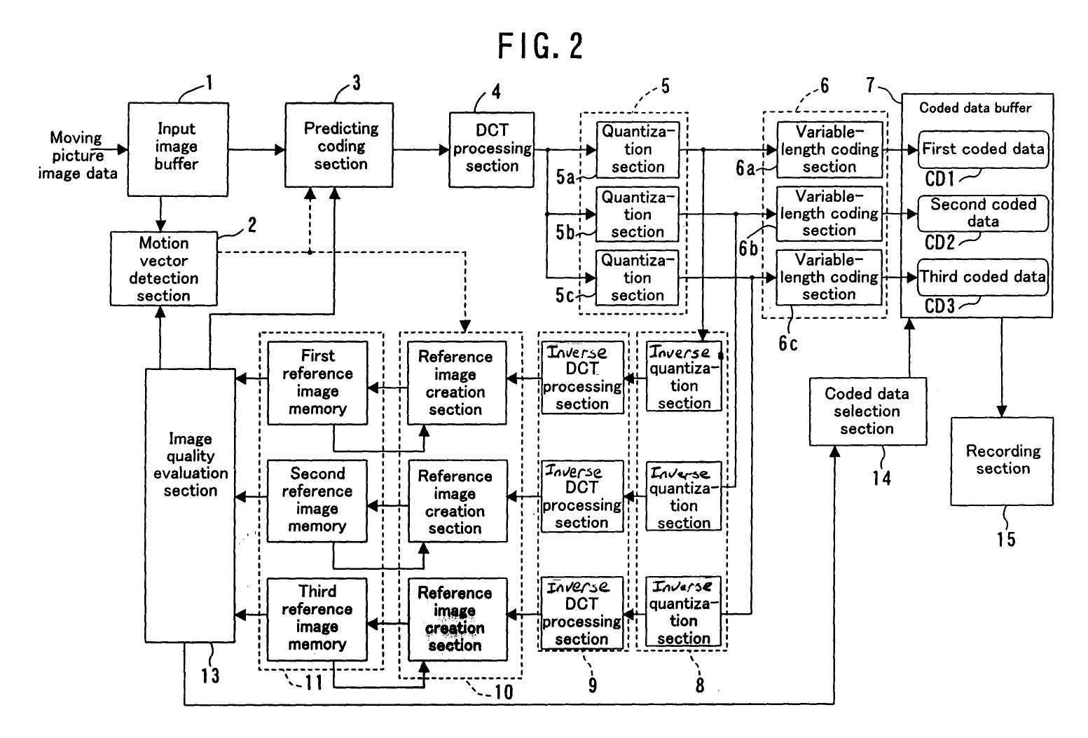

FIG. 2 is a block diagram for showing an exemplified architecture of a picture coding apparatus according to this embodiment. In FIG. 2, a motion vector detection section 2, a predicting coding section 3, a DCT processing section 4, a quantization block 5 and a variable-length coding block 6 together construct a picture coding unit, and an inverse quantization block 8, an inverse DCT processing block 9 and a reference image creation block 10 together construct a local decoding unit. For simplifying the architecture, the local decoding unit is supplied with the output of the quantization block 5 instead of a plurality of coded data CD1, CD2 and CD3.

Input moving picture image data is once stored in an input image buffer 1. The input image buffer 1 is necessary, together with a reference image memory 11, for detecting a motion vector and creating a predicting coded image, and its capacity corresponds to the number of lines necessary for forming a macroblock. The motion vector detection section 2 compares an image stored in the input image buffer 1 with a reference image, so as to detect a motion vector of the input image against the reference image in each macroblock. The predicting coding section 3 obtains a difference between the input image and the reference image on the basis of the detected motion vector data, so as to create a predicting coded image.

The predicting coded image is subsequently subjected to intraframe coding. First, in the DCT processing section 4, the DCT is executed so as to generate a DCT coefficient, which is quantized in the quantization block 5. In the architecture shown in FIG. 2, the quantization block 5 includes three quantization sections 5a, 5b and 5c respectively provided with different quantization coefficients, and the respective quantization sections 5a, 5b and 5c output quantized DCT coefficients. Next, theses DCT coefficients are coded in the variable-length coding block 6 through variable-length coding such as Haffman coding, and the thus generated first through third coded data CD1, CD2 and CD3 are stored in a coded data buffer 7.

On the other hand, the quantized DCT coefficients are respectively subjected to inverse quantization in the inverse quantization block 8 and then subjected to inverse DCT in the inverse DCT block 9, so as to be decoded to a predicting coded image. Then, in the reference image creation block 10, the decoded predicting coded image is added to the reference image of a previous frame stored in the reference image memory block 11 on the basis of the motion vector data, so as to decode a predicting coded image. Thus, a reference image to be used for predicting coding of an input image of a next frame is generated and stored in the reference image memory block 11. In this apparatus, three kinds of reference images are created.

An image quality evaluation section 13 evaluates the image qualities of these three kinds of reference images and selects one reference image on the basis of the evaluation result. A coded data selection section 14 selects, from the first through third coded data CD1, CD2 and CD3, the coded data corresponding to the reference image selected by the image quality evaluation section 13 and records the selected coded data in a recording section 15.

### Image Quality Evaluation

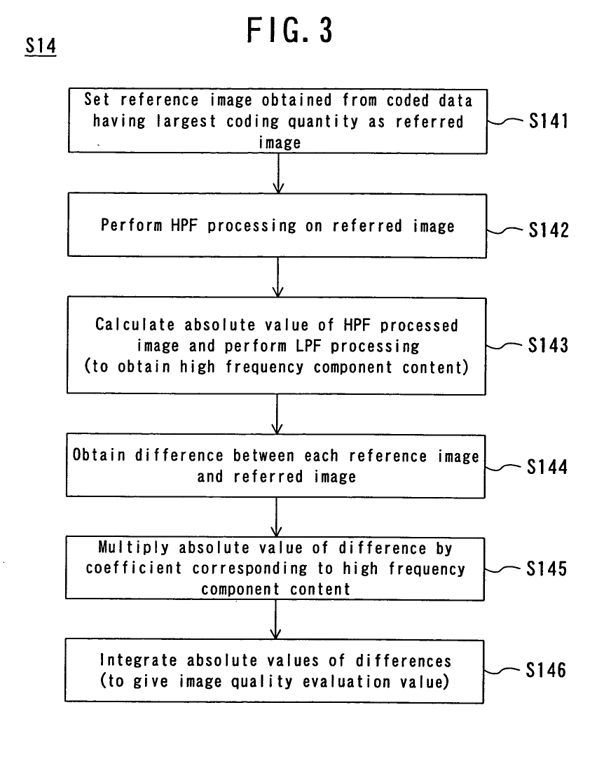

FIG. 3 is a flowchart of an example of processing executed in the image quality evaluation step S14. As shown in FIG. 3, the image quality evaluation of this embodiment is basically carried out as follows: A reference image obtained from coded data having the largest coding quantity is set as a referred image (S141), a difference between each reference image and the referred image is obtained in each pixel (S144), and the absolute values of the differences are integrated to be used as an evaluation value for the image quality evaluation (S146). The difference from the referred image is used as the evaluation scale because this difference can be regarded as noise caused through the image compaction. The absolute values of the differences are integrated over the whole image because the image quality evaluation is carried out in each frame in this embodiment. When the image quality evaluation is carried out in each macroblock, however, the absolute values of the differences are integrated with respect to each macroblock. In step S15, for example, reference images whose evaluations values obtained in step S14 fall within a predetermined allowable range are selected, so that coded data having the smallest coding quantity is selected from the coded data corresponding to the selected reference images.

In this embodiment, the reference image obtained from the coded data having the largest coding quantity is set as the referred image because the image quality is generally considered to be higher as the coding quantity is larger. Accordingly, in the case where a plurality of coded data are generated by using a plurality of coding parameters, a reference image obtained from coded data generated by using a coding parameter for attaining the highest image quality is set as the referred image.

However, influence of noise on image quality cannot be simply determined in accordance with the magnitude of the noise. For example, when noise caused in a complicatedly designed image and noise caused in a simply designed image are compared, the noise caused in the simply designed image is conspicuous in the whole image and hence can be said to have large influence.

Therefore, in the processing shown in FIG. 3, the extent of conspicuousness of noise in the image is incorporated in the evaluation value. Specifically, high frequency components of the referred image are extracted, and the above-described difference is modulated in accordance with the high frequency component of the corresponding pixel in obtaining the evaluation value. More specifically, the absolute value of the difference is set to be smaller as the high frequency component is larger.

First, the referred image is subjected to highpass filter (HPF) processing (S142). Thus, low frequency components are removed from the referred image. Since the image having the high frequency components alone has negative or positive values, these values are changed to absolute values, and the resultant is subjected to lowpass filter (LPF) processing (S143). This LPF processing is not always necessary but has an effect to make gentle the extent to modulate the differences. The result of this processing is defined as a high frequency component content. The absolute value of the difference obtained in step S144 is multiplied by a coefficient corresponding to the high frequency component content (S145). This coefficient is set to be smaller as the high frequency component content is larger. Ultimately, the absolute values of the differences having been multiplied by the coefficients are integrated over the whole image or with respect to each macroblock (S146).

A reproduced image can be further improved in the image quality by utilizing this difference. As described above, the difference from the referred image can be regarded as the noise component generated through the compaction. Therefore, a pattern of a difference image consisting of the differences is evaluated so as to extract noise information corresponding to a noise pattern included in the image, and this noise information is added to the coded data. When noise reduction processing for removing the noise pattern corresponding to this noise information is executed in reproducing the image, a reproduced image with high image quality can be obtained from coded data having a small coding quantity. Specifically, since the noise information is additionally included, there is no need to detect a noise component in the reproduced image, and hence, the noise can be accurately removed.

### EMBODIMENT 2

In Embodiment 1, the image quality evaluation is carried out in each frame so as to select coded data. In the case where the predicting coding is performed, however, reference images of another frame are used for the coding, and hence, the image quality is affected by the coding of this other frame. Therefore, it is preferred, if possible, that a plurality of coded data are generated with a plurality of conditions set over a plurality of frames, so as to evaluate the image qualities of images obtained from these coded data. Accordingly, in Embodiment 2 of the invention, the image quality evaluation is carried out in every two frames so as to select coded data. Specifically, a plurality of predicting coded images are generated by referring to a plurality of reference images of another frame, and with respect to each of the predicting coded images, coded data respectively having different coding qualities are generated.

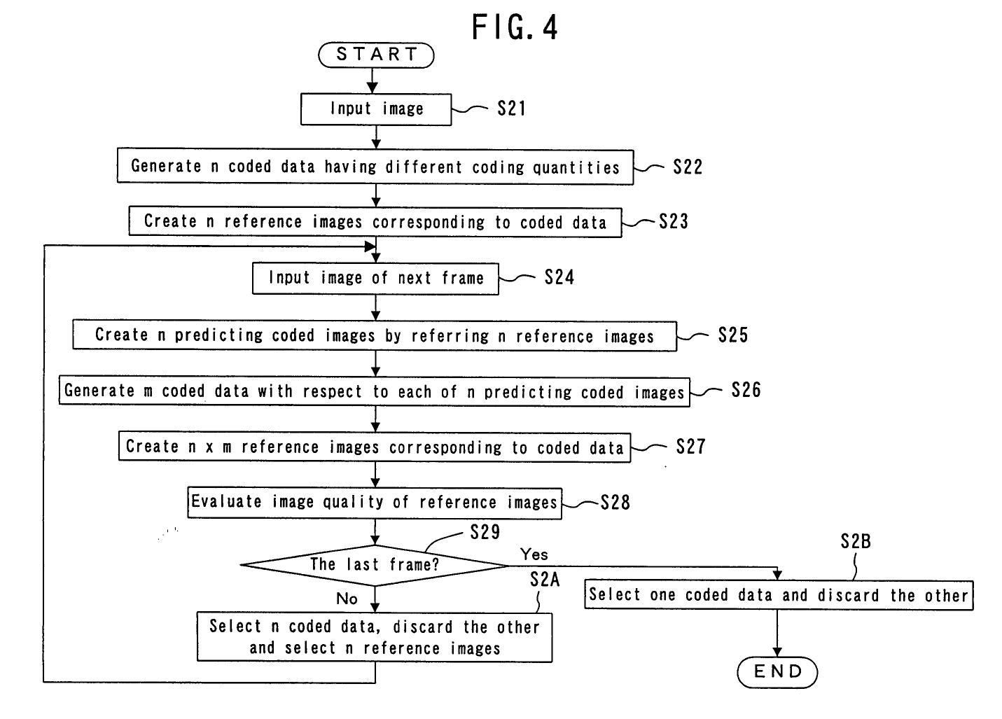

FIG. 4 is a flowchart for showing procedures in processing of a picture coding method according to this embodiment. In FIG. 4, a first frame of a moving picture image is input (S21), and n (wherein n is an integer of 2 or more) coded data respectively having different coding quantities are generated with respect to this frame image (S22). These n coded data are respectively decoded so as to create n reference images (S23).

Next, an image of a next frame is input (S24), and with respect to this input image, n predicting coded images are created with respect to this input image by referring to the n reference images (S25). With respect to each of the n predicting coded images, m (wherein m is an integer of 2 or more and is generally equal to n) coded data respectively having different coding quantities are generated, and thus, n×m coded data in total are generated (S26). These coded data are decoded so as to create n×m reference images (S28).

With respect to these reference images, the image quality evaluation is carried out in the same manner as in Embodiment 1 (S28), and coded data to be recorded is selected on the basis of the result of the image quality evaluation (S2A). In this manner, the image quality evaluation is carried out on a combination of the coded data of the two frames. Furthermore, on the basis of the result of the image quality evaluation, n reference images are selected from the n×m reference images (S2A). These n reference images are used for the predicting coding of a next frame image.

This processing is repeatedly executed until the last frame is processed (S29). In the processing of the last frame, one coded data to be ultimately recorded is selected on the basis of the result of the image quality evaluation (S2B).

### EMBODIMENT 3

In the above-described embodiments, the intra/inter determination is performed with respect to each macroblock of one frame, and for example, intra-coding or intercoding having smaller coding quantity with using the same coding parameter is selected. However, a reference image has already been degraded in its image quality because of the coding, and the image quality is further degraded through the coding using a predicting coded image. Therefore, it is preferred that the intra/inter determination is also carried out through the image quality evaluation. In this embodiment, the intralinter determination is also carried out through the image quality evaluation.

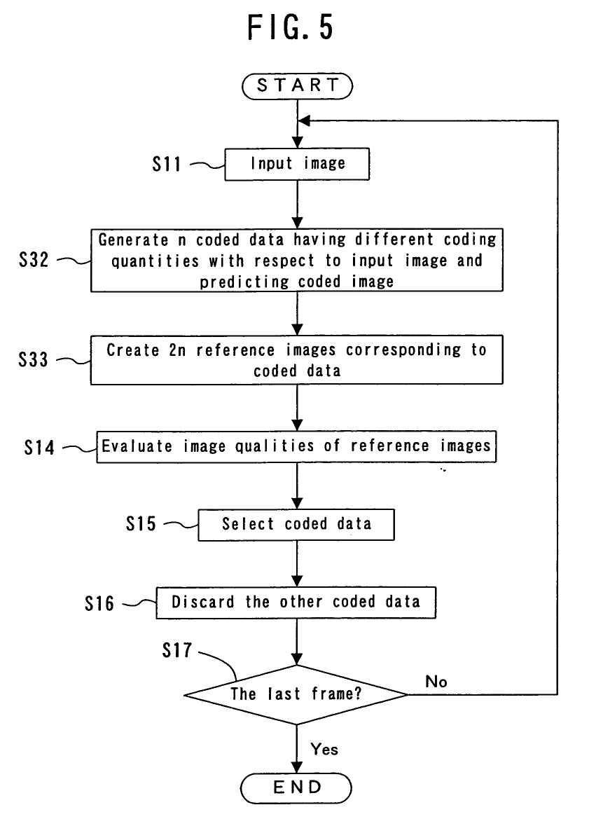

FIG. 5 is a flowchart of a method obtained by additionally performing the intra/inter determination through the image quality evaluation in the picture coding method according to Embodiment 1 shown in FIG. 1. Differences from the flowchart of FIG. 1 are steps S32 and S33. In step S32, n coded data respectively having different coding quantities are generated with respect to each of an input image and a predicting coded image, and in step S33, 2n reference images are created from the 2n coded data generated in step S32. With respect to these 2n reference images, the image quality evaluation is carried out (S14) so as to select coded data (S15). Thus, the inter-intra determination carried out within each frame in Embodiment 1 can be performed through the image quality evaluation.

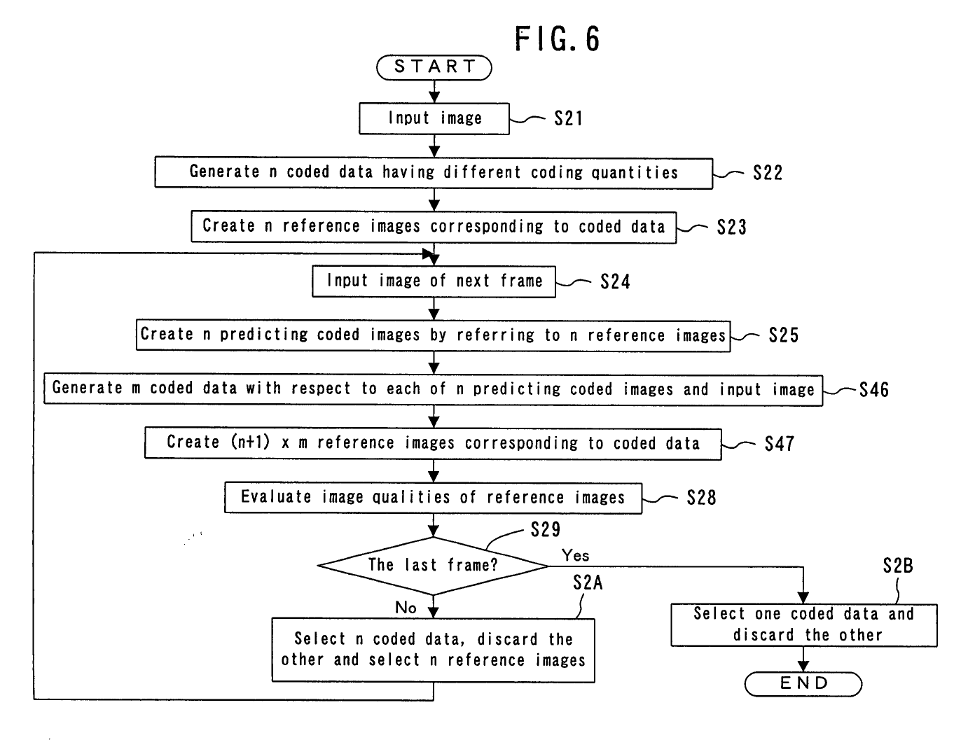

FIG. 6 is a flowchart of a method obtained by additionally performing the intra/inter determination through the image quality evaluation in the picture coding method according to Embodiment 2 shown in FIG. 4. Differences from the flowchart of FIG. 4 are steps S46 and S47. In step S46, with respect to each of an input image and n predicting coded images, m coded data respectively having different coding quantities are generated, and in step S47, (n+1)×m reference images are created from the (n+1)×m coded data generated in step S46. With respect to these (n+1)×m reference images, the image quality evaluation is carried out (S28), so as to select coded data (S2A). Thus, the intra/inter determination performed within each frame in Embodiment 2 can be carried out through the image quality evaluation.

### EMBODIMENT 4

In each of the aforementioned embodiments, coded data is selected on the basis of the image quality evaluation strictly in each frame. Also, in the case where the intra/inter determination is performed through the image quality evaluation in each frame as described in Embodiment 3, macroblocks are all predicting coded images or all input images. Therefore, in Embodiment 4 of the invention, the coding quantity control of each macroblock of one frame is also performed through the image quality evaluation.

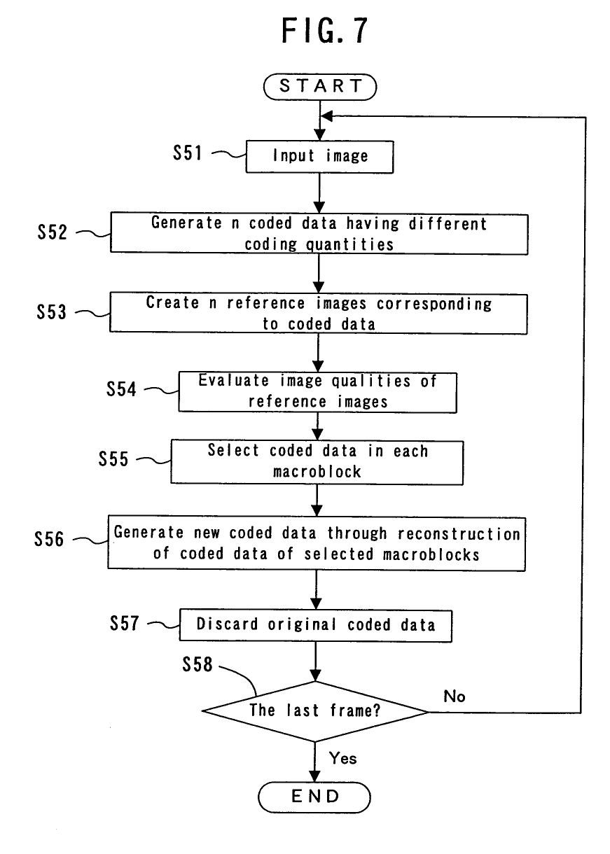

FIG. 7 is a flowchart for showing procedures in a picture coding method according to Embodiment 4 of the invention. In FIG. 7, a first frame of a moving picture image is input (S51), and with respect to this frame image, n coded data respectively having different coding quantities are generated (S52). In this case, n different coding parameters are used in the coding for generating the n coded data. Specifically, without controlling the coding quantity by providing different coding parameters to respective macroblocks, the respective coded data are obtained through the coding using the same coding parameter with respect to all the macroblocks.

The n coded data are respectively decoded, so as to create n reference images (S53). Then, the n reference images are subjected to the image quality evaluation (S54). The image quality evaluation is executed with respect to each macroblock, and hence, an optimum image is selected in each macroblock. In other words, different reference images may be selected among the respective macroblocks. Next, coded data corresponding to the reference image selected with respect to each macroblock is extracted from the n coded data (S55), and new coded data is generated by combining the extracted coded data (S56). The original coded data are discarded (S57). Then, steps S51 through S57 are repeatedly executed until the last frame is processed (S58).

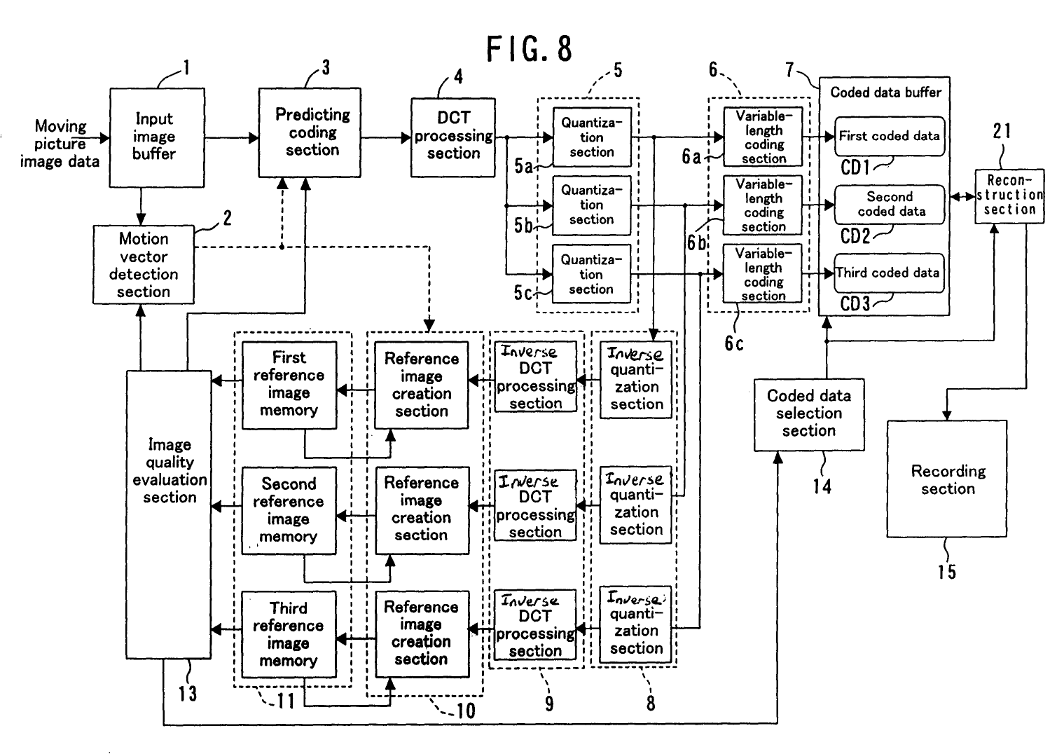

FIG. 8 is a block diagram for showing an exemplified architecture of a picture coding apparatus according to this embodiment, wherein like reference numerals are used to refer to like elements shown in FIG. 2 so as to omit the detailed description. In the architecture shown in FIG. 8, a reconstruction section 21 for generating, in accordance with an instruction from the coded data selection section 14, new coded data through reconstruction from the first through third coded data CD1, CD2 and CD3 stored in the coded data buffer 7 is provided.

### Reconstruction of Coded Data

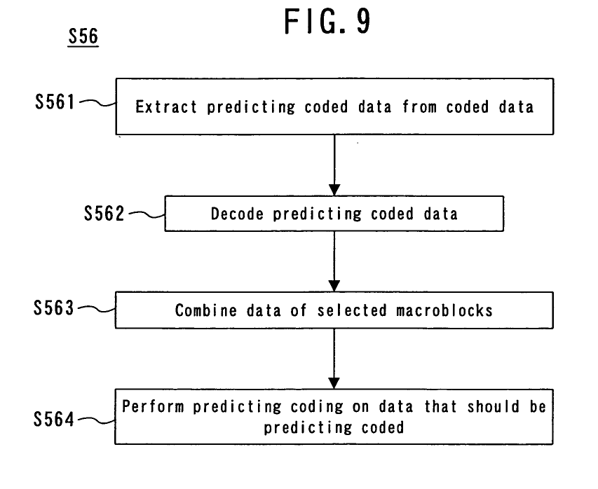

FIG. 9 is a flowchart of an example of processing performed in the coded data reconstruction step S56. If the coding is performed independently in each macroblock, coded data of necessary macroblocks are simply taken out and combined for reconstructing coded data. However, part of data may have been subjected to the predicting coding (intraframe predicting coding) in which a difference from coded data of another macroblock is coded. In this case, the predicted coded data are once decoded, and decoded data of necessary macroblocks are combined to obtain new coded data, which is subjected to the predicting coding again.

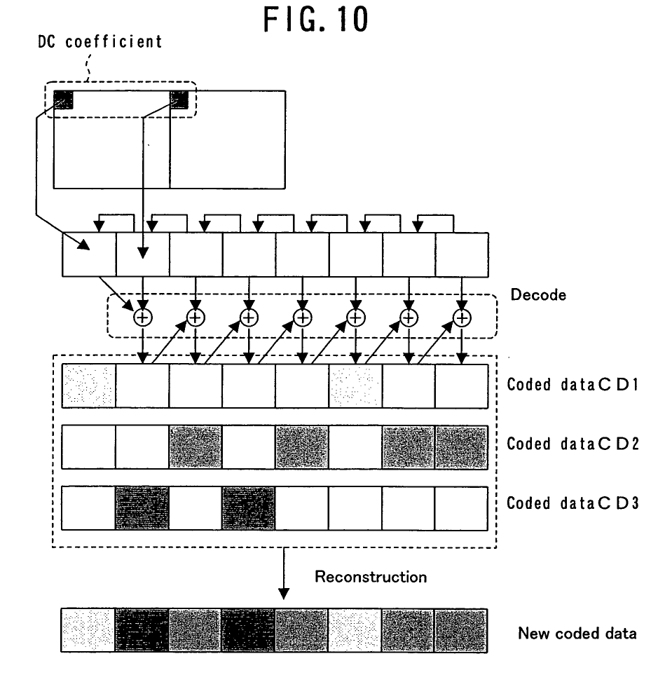

FIG. 10 is a schematic diagram of the reconstruction processing for coded data including intraframe coded data. First, intraframe predicting coded data are extracted from the coded data of the macroblocks (S561). This is because not all the coded data of the macroblocks are intraframe predicting coded data but merely part of the data, such as a DC coefficient of the DCT, are intraframe predicting coded data. Subsequently, the intraframe predicting coded data are decoded (S562). As shown in FIG. 10, data of a first macroblock (herein, a DC coefficient) is directly used. Data of a second macroblock corresponds to a difference from the data of the first macroblock and hence is decoded to original data by adding to the data of the first macroblock. Then, data of a third macroblock is added to the decoded data of the second macroblock, thereby being decoded to original data of the third macroblock. Through this processing, coded data having been coded without the intraframe predicting coding can be obtained.

Next, coded data corresponding to reference images selected in the respectively macroblocks through the image quality evaluation are extracted and combined, so as to reconstruct one coded data (S563). In FIG. 10, coded data of each macroblock is extracted from the three coded data CD1 through CD3, so as to reconstruct one new coded data. Ultimately, among the new coded data thus reconstructed, some that should be subjected to the predicting coding (herein, a DC coefficient of the DCT) are subjected to the predicting coding again.

### Selection of Coded data in Consideration of Coding Quantity

In the case where the coding quantity is controlled through the image quality evaluation alone, the coding quantity is varied in accordance with variation in complexity of the image, and hence, the coding quantity is largely varied. When the coding quantity is largely varied, it is necessary to prepare a large buffer memory for decoding data in reproducing, which is disadvantageous in downsizing of equipment and reducing cost. Therefore, in a method described below, coded data is selected not only through the image quality evaluation but also in consideration of the coding quantity, so as to suppress the variation of the coding quantity to a given extent.

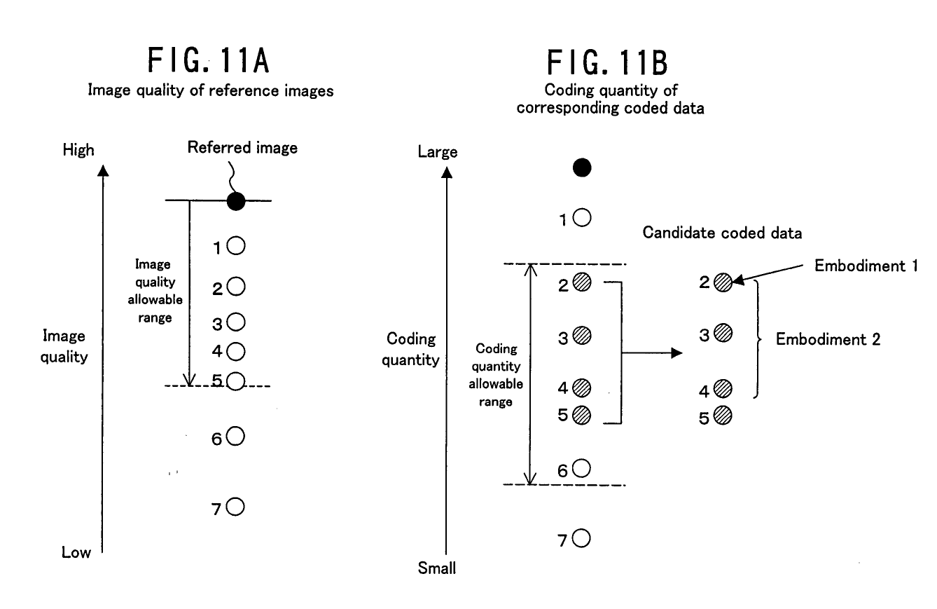

Basically, an allowable range (designated as the “coding quantity allowable range”) is set with respect to the coding quantity, and coded data having coding quantities falling in the coding quantity allowable range are selected from coded data corresponding to reference images having image qualities falling in the above-described image quality allowable range, so that coded data to be recorded can be selected from these selected coded data in accordance with a predetermined rule. This processing will be described with reference to FIGS. 11A and 11B. FIG. 11A schematically shows the image qualities of reference images. In FIG. 11A, the ordinate indicates the image quality, and the image quality is higher upward. FIG. 11B schematically shows the coding quantities of coded data corresponding to the respectively reference images. In FIG. 11B, the ordinate indicates the coding quantity, and the coding quantity is larger upward.

In FIG. 11A, a referred image having the highest image quality is placed in the uppermost position, and the reference images to be compared are arranged below. Among the reference images, the reference images 1 through 5 have the image qualities falling in the image quality allowable range. Also in FIG. 11B, the coded data of the referred image having the largest coding quantity is placed in the uppermost position, and the coded data corresponding to the reference images are arranged below. This arrangement order is generally the same as the order of the image quality. Among these coded data, the coded data 2 through 6 have the coding quantities falling in the coding quantity allowable range.

In this case, coded data that have the coding quantities falling in the coding quantity allowable range and correspond to the reference images having the image qualities falling in the image quality allowable range are four and specifically, the coded data 2 through 5. Among these coded data, coded data to be recorded is selected. For example, in the case where the image quality evaluation is executed in each frame as in Embodiment 1, the coded data 2 is selected. Alternatively, in the case where the image quality evaluation is executed in every two frames as in Embodiment 2, for example, the coded data 2 through 4 are selected.

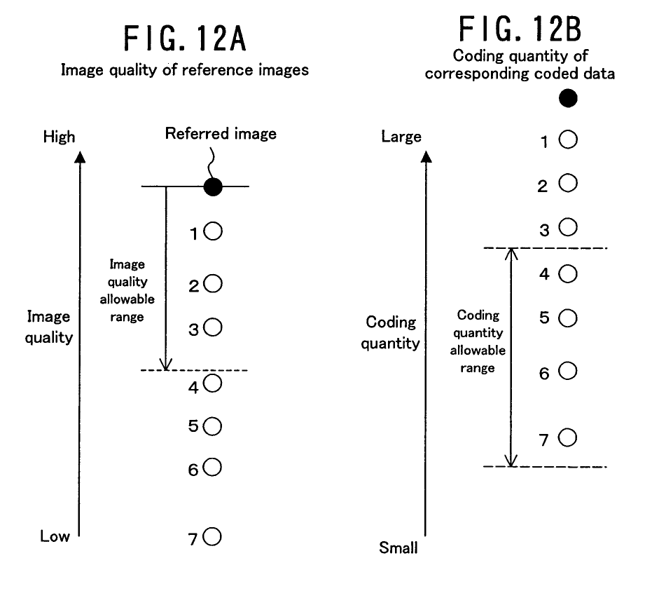

Alternatively, in the case where none of coded data corresponding to reference images having the image quantities falling in the image quality allowable range has a coding quantity falling in the coding quantity allowable range as shown in FIGS. 12A and 12B, for example, coded data having the largest coding quantity in the coding quantity allowable range may be selected. This is because this coded data can be regarded to have the highest image quality among the coded data having the coding quantities falling in the coding quantity allowable range. In this case, also in the method where a plurality of coded data are selected, merely one coded data having the largest coding quantity is preferably selected. This is because there is a very small possibility that other coded data having too low image qualities are selected through the evaluation over a plurality of frames.

When this method is employed with respect to each frame, since the variation range of the coding quantity is large, it is necessary to set the allowable range to be small as compared with the variation range. When this method is employed with respect to each macroblock, however, since the variation range is small, the allowable range can be easily set to be large as compared with the variation range. In the case where the coding quantity is varied in the same manner in all the macroblocks, however, the coding quantity is largely varied over the whole frame, which is not preferred.

Accordingly, preferably, the coding quantity allowable range is set with respect to each frame, coded data is selected through the image quality evaluation in each macroblock, and when the coding quantity of the whole frame is above the coding quantity allowable range, selection of coded data in each frame is reconsidered so that the coding quantity can fall in the allowable range. In this case, the coded data to be selected is changed preferentially in a macroblock that is less degraded in the image quality and is more largely reduced in the coding quantity through the selection change. Thus, the coding quantity can be controlled with minimizing the image quality degradation in the whole frame.

### Exemplified Architectures of Devices

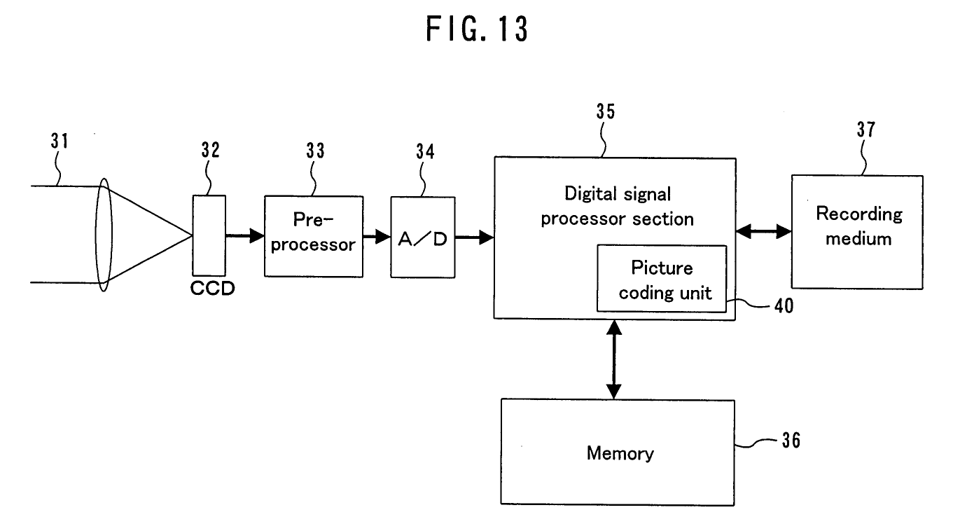

Now, specific examples of the application of the invention will be described. First, the invention is applied to a digital camera. FIG. 13 is a diagram for showing the architecture of a general digital camera. First, an optical image formed by a lens 31 is converted into an electric signal by a CCD image sensor 32, the resultant signal is subjected to preprocessing by an analog preprocessing section 33, and the preprocessed signal is converted into a digital signal by an A/D converter section 34. A digital signal processor section 35 processes the digital signal for color separation and compaction, and a memory with large capacity is necessary for this processing. In the digital camera, an external memory 36, such as a DRAM, is used as the memory with large capacity. The digital signal having been thus processed is recorded in a recording medium 37.

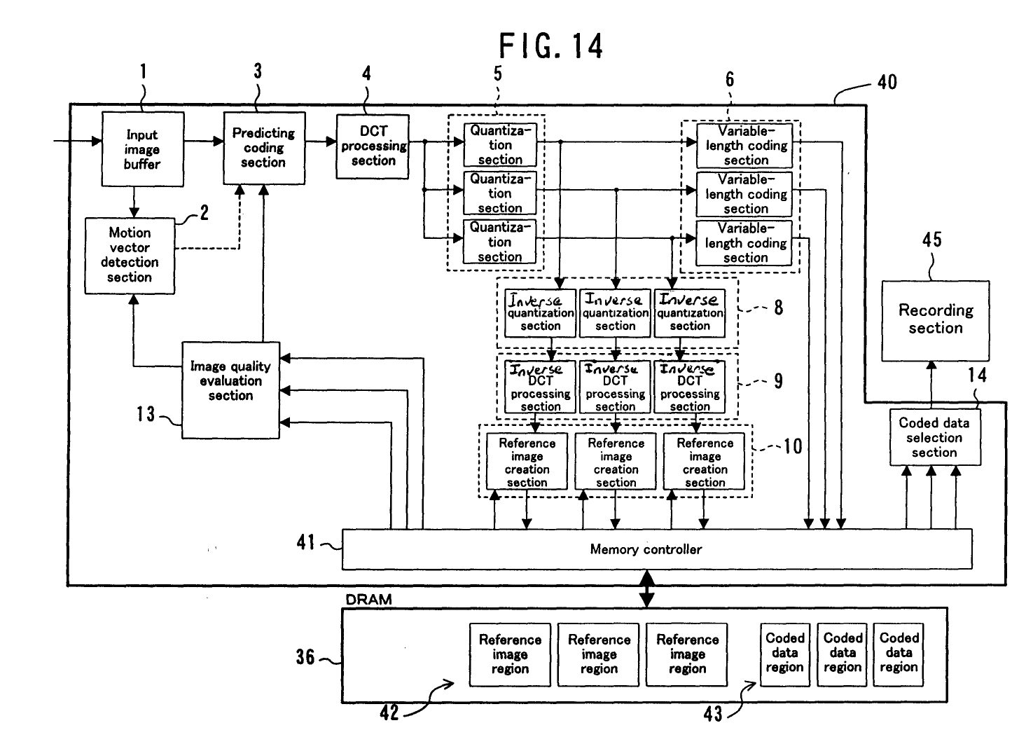

In this manner, since the digital camera is originally equipped with the memory with large capacity, this memory is preferably used in applying the present invention. FIG. 14 shows the architecture of a picture coding unit 40 of a digital camera to which the present invention is applied. This picture coding unit 40 is provided within the digital signal processor section 35, and basically has the same architecture and operation as those shown in FIG. 2. A memory controller 41 arbitrates data input/output to and from respective sections, and sends and accepts data to and from the external memory 36 with large capacity such as a DRAM working as a memory device. In the architecture of FIG. 14, the memory 36 has a region 42 for storing a plurality of reference images and a region 43 for storing a plurality of coded data. Specifically, reference images created by a reference image creation section 10 are stored in the external memory 36 via the memory controller 41, and coded data are also stored in the external memory 36 via the memory controller 41. In other words, both the coded data buffer 7 corresponding to a first storage section and the reference image memory block 11 corresponding to a second storage section in the architecture of FIG. 2 are constructed by the external memory 36 serving as a common memory device.

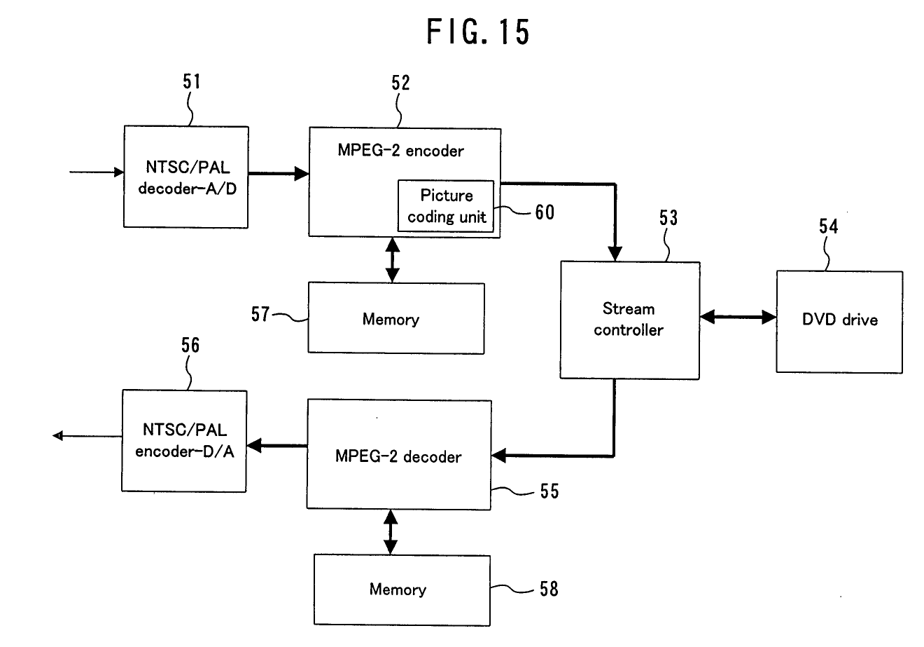

Next, a specific example of the application to a video recorder utilizing MPEG-2, such as a DVD recorder, will be described. FIG. 15 shows an exemplified architecture of a DVD recorder for coding a moving picture image of TV resolution by using MPEG-2. First, an NTSC/PAL decoder-A/D section 51 performs, on an NTSC or PAL signal, Y/C separation, color demodulation and AD conversion. Next, an MPEG-2 encoder 52 generates coded data by encoding the digital signal in accordance with the MPEG-2. Then, a stream controller 53 performs arbitration and input/output control of recording/reproducing stream data for a DVD drive 54. In reproducing, an MPEG-2 decoder 55 generates an image signal through decoding in accordance with the MPEG-2, and an NTSC/PAL encoder-D/A section 56 performs modulation and DA conversion so as to obtain an NTSC or PAL signal. The MPEG-2 encoder 52 and the MPEG-2 decoder 55 are respectively connected to external memories 57 and 58 with large capacity to be used for processing.

A DVD recorder is generally used for recording a moving picture image with a comparatively large screen size, that is, a TV screen, with a high image quality. Therefore, high processing performance and a memory with large capacity are indispensable, and coded data with comparatively low compressibility are generated for realizing a high image quality under these conditions. On the other hand, there also exists a need that coded data with a coding quantity as small as possible (namely, high compressibility) is desired to be obtained even in a small screen size (with low resolution). To meet such a need, in conventional technique, resolution is converted so as to record data of a small screen in accordance with the MPEG-2. When the present invention is applied, however, coded data with high image quality and high compressibility can be obtained. Therefore, without increasing the circuit scale, the aforementioned need can be easily satisfied through time-sharing operation of a picture coding apparatus, such as a DVD recorder, originally having high processing performance for carrying out the coding by using a plurality of coding parameters.

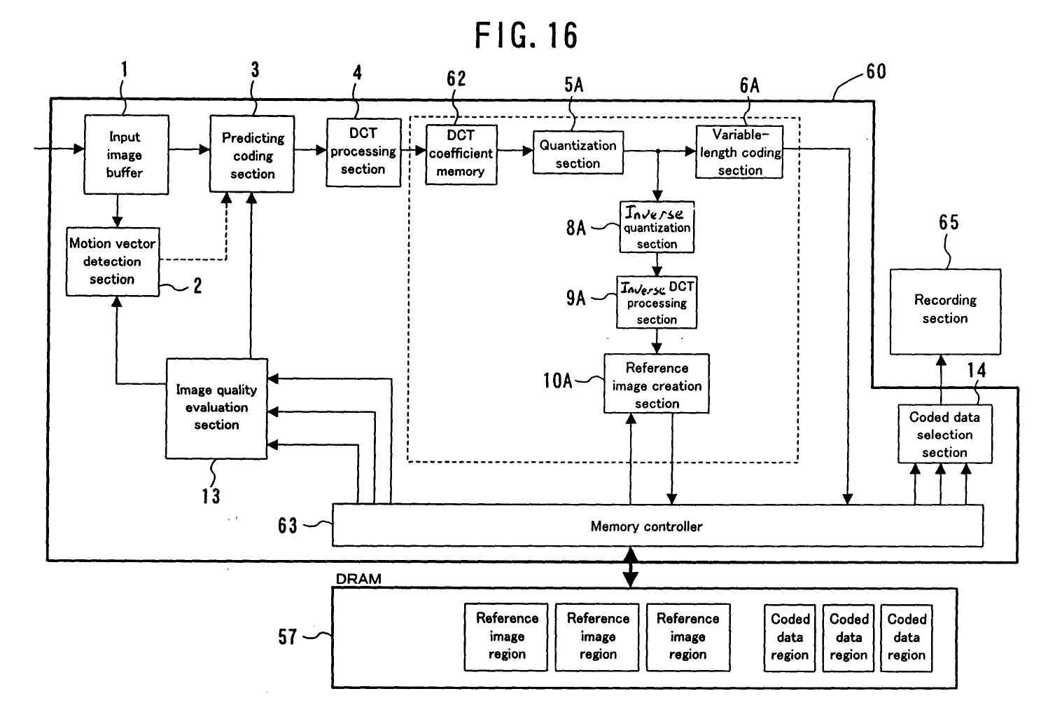

FIG. 16 shows the architecture of a picture coding unit 60 of a DVD recorder to which the present invention is applied. This architecture is basically the same as that shown in FIG. 14, but a quantization section 5A, a variable-length coding section 6A and a local decoding section (including an inverse quantization section 8A, an inverse DCT processing section 9A and a reference image creation section 10A) are provided one each in the number differently from the architecture of FIG. 14. Also, a DCT coefficient memory 62 for storing a DCT coefficient is additionally provided between a DCT processing section 4 and the quantization section 5A.

First, in a general operation of the DVD recorder, one coded data is generated with respect to one image. In contrast, in the case where an image of a small screen is coded with high compressibility, a DCT coefficient output from the DCT processing section 4 is stored in the DCT coefficient memory 62. With respect to this stored data, the following processing are performed plural times by using different coding parameters in a time-sharing manner: First, the data is quantized and variable-length coded by using a coding parameter a. Thereafter, the resultant data is subjected to inverse quantization, inverse DCT and reference image creation, so as to obtain a reference image A. Next, the data is quantized and variable-length coded by using a coding parameter b. Thereafter, the resultant data is subjected to the inverse quantization, the inverse DCT and the reference image creation, so as to obtain a reference image B. The processing are performed in the same manner in the case where other different coding parameters are used. These processing are performed with respect to each macroblock, and when the processing for one screen is completed, a plurality of coded data and reference images are obtained. Thereafter, coded data is selected in accordance with predetermined conditions as described in each of the aforementioned embodiments.

In this manner, according to the present invention, coded data is selected on the basis of the result of the image quality evaluation of reference images that are identical to images obtained in reproducing, and therefore, the coding quantity can be controlled in consideration of the image quality. Accordingly, coded data with an appropriate coding quantity and high image quality can be definitely obtained.

What is claimed is:

1. A picture coding method for coding a moving picture image, comprising:
a first step of generating, with respect to a first image, a plurality of coded data respectively having different coding quantities;
a second step of creating a plurality of reference images to be used for predicting coding by decoding said plurality of coded data;
a third step of performing image quality evaluation on said plurality of reference images; and
a fourth step of selecting at least one coded data from said plurality of coded data on the basis of a result of the image quality evaluation.

2. The picture coding method of claim 1,
wherein, in the first step, a plurality of target coding quantities are set, and said plurality of coded data are generated with respect to said first image, through coding performed under coding quantity control for converging coding quantities of said plurality of coded data respectively on said plurality of target coding quantities.

3. The picture coding method of claim 2,
wherein said plurality of target coding quantities are set with respect to each frame, and
in the coding quantity control, a coding parameter is controlled in each macroblock.

4. The picture coding method of claim 1,
wherein, in the first step, said plurality of coded data are generated with respect to said first image, through coding performed by using a plurality of different coding parameters.

5. The picture coding method of claim 1,
wherein said first image is provided frame by frame, and
said at least one coded data is selected in each frame in the fourth step.

6. The picture coding method of claim 1,
wherein said first image is provided frame by frame,
in the first step, n (wherein n is an integer of 2 or more) predicting coded images are created, with respect to said first image, by referring to n reference images of another frame, and
with respect to each of said n predicting coded images, m (wherein m is an integer of 2 or more) coded data respectively having different coding quantities are generated, whereby generating n×m coded data as said plurality of coded data.

7. The picture coding method of claim 6,
wherein, in the fourth step, n coded data are selected from said n×m coded data, and n reference images respectively corresponding to said n coded data are used for the predicting coding of an image of another frame.

8. The picture coding method of claim 1,
wherein, in the third step, a reference image obtained from coded data having the largest coding quantity among said plurality of reference images is set as a referred image, and
a difference of each of said reference images from said referred image is obtained and used for obtaining an evaluation value for the image quality evaluation.

9. The picture coding method of claim 8,
wherein, in the fourth step, said at least one code data is selected from coded data corresponding to reference images having evaluation values falling in an allowable range.

10. The picture coding method of claim 8,
wherein, in the third step, a high frequency component is extracted from said referred image, and
in obtaining said evaluation value, said difference is modulated in accordance with said high frequency component of a corresponding pixel.

11. The picture coding method of claim 8,
wherein a pattern of a difference image consisting of said difference is evaluated and noise information is extracted from said pattern, and
said noise information is additionally included in coded data corresponding to a corresponding one of said reference images.

12. The picture coding method of claim 1,
wherein, in the third step, the image quality evaluation of said reference images is performed in each macroblock, and
in the fourth step, said at least one coded data is selected in each macroblock, and said coded data selected in respective macroblocks are combined to reconstruct new coded data.

13. The picture coding method of claim 12,
wherein, in the fourth step, in reconstructing said new coded data, some of said selected coded data that have been coded through the predicting coding are once decoded to obtain coded data having been coded without the predicting coding before reconstruction, and are subjected to the predicting coding again after the reconstruction.

14. The picture coding method of claim 1,
wherein said first image is provided frame by frame, in the first step, inter-coding and intra-coding are performed with respect to said first image, and
in the fourth step, either of the inter-coding or the intra-coding is selected.

15. The picture coding method of claim 1,
wherein, in the fourth step, said at least one coded data is selected on the basis of not only the result of the image quality evaluation but also coding quantities of said plurality of coded data.

16. The picture coding method of claim 15,
wherein, in the fourth step, an image quality allowable range is set as an allowable range of said evaluation value resulting from the image quality evaluation and a coding quantity allowable range is set as an allowable range of said coding quantities, and said at least one coded data is selected in accordance with a given rule from coded data having evaluation values falling in said image quality allowable range and having coding quantities falling in said coding quantity allowable range.

17. The picture coding method of claim 15,
wherein, in the fourth step, a coding quantity allowable range is set in each frame as an allowable range of said coding quantities,
said at least one coded data is selected through the image quality evaluation in each macroblock, and
when a coding quantity of a whole frame is above said coding quantity allowable range, the selection of said at least one coded data is changed, for making said coding quantity of said frame fall in said coding quantity allowable range, preferentially in a macroblock that is less degraded in the image quality and more largely reduced in the coding quantity through change of the selection.

18. A picture coding apparatus comprising:
a picture coding unit for generating, with respect to a first image, a plurality of coded data respectively having different coding quantities;
a local decoding unit for generating a plurality of reference images to be used for predicting coding by locally decoding said plurality of coded data generated by said picture coding unit;
an image quality evaluation section for evaluating image qualities of said plurality of reference images generated by said local decoding unit; and
a coded data selection section for selecting at least one coded data from said plurality of coded data on the basis of a result of processing executed by said image quality evaluation section.

19. The picture coding apparatus of claim 18, further comprising:
a first storage section for storing said plurality of coded data; and
a second storage section for storing said plurality of reference images, wherein said first storage section and said second storage section are constructed by a common memory device.

20. The picture coding apparatus of claim 18,
wherein said picture coding unit and said local decoding unit are operated in a time-sharing manner for generating combinations of said plurality of coded data and said plurality of reference images serially in time series.
